(19) United States
(12) Patent Application Publication
(10) Pub. No.: US 2026/0197739 A1
(43) Pub. Date: Jul. 9, 2026

(54) MITIGATING RADIO LINK CONTROL LAYER DEGRADATION ASSOCIATED WITH A SPLIT BEARER

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US); Vaishakh RAO, San Diego, CA (US); Vishal DALMIYA, San Diego, CA (US); Gautham Kumar Reddy ADIREDDY, San Diego, CA (US); Dustin LIEU, San Diego, CA (US)

(21) Appl. No.: 19/014,937

(22) Filed: Jan. 9, 2025

(51) Int. Cl. H04W 36/30; H04B 17/318; H04L 41/5009

(52) U.S. Cl. CPC H04W 36/302; H04B 17/328; H04L 41/5009

(57) ABSTRACT

Various aspects of the present disclosure generally relate to wireless communication. In some aspects, a user equipment (UE) may receive a configuration associated with mitigating a radio link control (RLC) layer degradation. The UE may detect the RLC layer degradation based at least in part on an occurrence of an event, wherein the RLC layer degradation is between a first RLC layer and a second RLC layer that are associated with a split bearer. The UE may perform a corrective action to mitigate the RLC layer degradation based at least in part on the configuration. Numerous other aspects are described.

### FIELD OF THE DISCLOSURE

Aspects of the present disclosure generally relate to wireless communication and specifically relate to techniques, apparatuses, and methods associated with mitigating radio link control layer degradation associated with a split bearer.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing,

among other examples. As the demand for connectivity continues to increase, further improvements in NR may be implemented, and other RATs, such as 6G and beyond, may be introduced to enable new applications and facilitate new use cases.

### SUMMARY

In some implementations, an apparatus for wireless communication at a user equipment (UE) includes one or more memories; and one or more processors, coupled to the one or more memories, configured to cause the UE to: receive a configuration associated with mitigating a radio link control (RLC) layer degradation; detect the RLC layer degradation based at least in part on an occurrence of an event, wherein the RLC layer degradation is between a first RLC layer and a second RLC layer that are associated with a split bearer; and perform a corrective action to mitigate the RLC layer degradation based at least in part on the configuration.

In some implementations, an apparatus for wireless communication at a network node includes one or more memories; and one or more processors, coupled to the one or more memories, configured to cause the network node to: transmit a configuration associated with mitigating an RLC layer degradation; and receive an indication of a corrective action performed to mitigate the RLC layer degradation in accordance with the configuration, wherein the RLC layer degradation is detected based at least in part on an occurrence of an event, and wherein the RLC layer degradation is between a first RLC layer and a second RLC layer that are associated with a split bearer.

In some implementations, a method of wireless communication performed by a UE includes receiving a configuration associated with mitigating an RLC layer degradation; detecting the RLC layer degradation based at least in part on an occurrence of an event, wherein the RLC layer degradation is between a first RLC layer and a second RLC layer that are associated with a split bearer; and performing a corrective action to mitigate the RLC layer degradation based at least in part on the configuration.

In some implementations, a method of wireless communication performed by a network node includes transmitting a configuration associated with mitigating an RLC layer degradation; and receiving an indication of a corrective action performed to mitigate the RLC layer degradation in accordance with the configuration, wherein the RLC layer degradation is detected based at least in part on an occurrence of an event, and wherein the RLC layer degradation is between a first RLC layer and a second RLC layer that are associated with a split bearer.

In some implementations, a non-transitory computer-readable medium storing a set of instructions for wireless communication includes one or more instructions that, when executed by one or more processors of a UE, cause the UE to: receive a configuration associated with mitigating an RLC layer degradation; detect the RLC layer degradation based at least in part on an occurrence of an event, wherein the RLC layer degradation is between a first RLC layer and a second RLC layer that are associated with a split bearer; and perform a corrective action to mitigate the RLC layer degradation based at least in part on the configuration.

In some implementations, a non-transitory computer-readable medium storing a set of instructions for wireless communication includes one or more instructions that, when executed by one or more processors of a network node, cause the network node to: transmit a configuration associated with mitigating an RLC layer degradation; and receive an indication of a corrective action performed to mitigate the RLC layer degradation in accordance with the configuration, wherein the RLC layer degradation is detected based at least in part on an occurrence of an event, and wherein the RLC layer degradation is between a first RLC layer and a second RLC layer that are associated with a split bearer.

In some implementations, an apparatus for wireless communication includes means for receiving a configuration associated with mitigating an RLC layer degradation; means for detecting the RLC layer degradation based at least in part on an occurrence of an event, wherein the RLC layer degradation is between a first RLC layer and a second RLC layer that are associated with a split bearer; and means for performing a corrective action to mitigate the RLC layer degradation based at least in part on the configuration.

In some implementations, an apparatus for wireless communication includes means for transmitting a configuration associated with mitigating an RLC layer degradation; and means for receiving an indication of a corrective action performed to mitigate the RLC layer degradation in accordance with the configuration, wherein the RLC layer degradation is detected based at least in part on an occurrence of an event, and wherein the RLC layer degradation is between a first RLC layer and a second RLC layer that are associated with a split bearer.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example disaggregated network node architecture, in accordance with the present disclosure.

FIG. 3 is a diagram illustrating an example of a radio protocol architecture, in accordance with the present disclosure.

FIG. 4 is a diagram illustrating an example of a split bearer difference, in accordance with the present disclosure.

FIG. 5 is a diagram illustrating an example associated with mitigating radio link control layer degradation associated with a split bearer, in accordance with the present disclosure.

FIG. 6 is a flowchart illustrating an example process performed, for example, by a UE, in accordance with the present disclosure.

FIG. 7 is a flowchart illustrating an example process performed, for example, by a network node, in accordance with the present disclosure.

FIGS. 8-9 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

At a user equipment (UE), a split bearer may be associated with a packet data convergence protocol (PDCP) layer, where the PDCP layer may be associated with a first radio link control (RLC) layer and a second RLC layer. The first RLC layer may

be associated with a first leg and the second RLC layer may be associated with a second leg. In some cases, an RLC roundtrip time (RTT) difference across the first RLC layer and the second RLC layer may vary. For example, an RLC RTT difference may be higher than 10 milliseconds (ms) between the first RLC layer and the second RLC layer. An RLC RTT may be an amount of time for an RLC layer to receive an RLC acknowledgement (ACK). The RLC RTT difference may be due to one RLC being associated with a favorable channel condition and another RLC being associated with an unfavorable channel condition. In this case, the first RLC layer may have a low RTT, and the second RLC layer may have a high RTT.

A network node may depend on a measurement event to deactivate a secondary cell group (SCG). For example, an A2 event may occur when a measurement associated with a serving cell becomes worse than an absolute threshold. When the A2 event is detected, the network node may deactivate the SCG. However, an RLC RTT difference across RLC layers at a UE may start to grow significantly, which may impact latency and memory consumption, without triggering the detection of the A2 event. For example, a first RLC layer may be associated with a favorable channel condition (e.g., low RTT) and a second RLC layer may be associated with an unfavorable channel condition (e.g., high RTT), which may cause the RLC RTT difference, but the RLC RTT difference may not necessarily trigger the detection of the A2 event. Without the detection of the A2 event, the SCG may not be deactivated, and the second RLC layer associated with the unfavorable channel condition may continue to be used. Without the detection of the A2 event and without a triggering of an A2 measurement report, the second RLC layer associated with the unfavorable channel condition may not be deactivated in a timely manner. An uplink split threshold (ul-SplitThreshold) may force the UE to transmit data via the second RLC layer associated with the unfavorable channel condition, even when an RLC RTT increases on the second RLC layer, which may cause even more RLC RTT difference across the first RLC layer and the second RLC layer. Existing measurement reports such as A2 may not be sufficient for good split bearer performance. The A2 event may not be triggered while the RLC RTT difference is growing, and/or corrective action may be delayed. For example, a user plane may experience significant degradation before the A2 event is triggered and a behavior is corrected (e.g., releasing the SCG). As a result, the RLC RTT difference across RLC layers may result in an overall degradation in system performance.

Various aspects relate generally to RLC layer degradation. Some aspects more specifically relate to mitigating RLC layer degradation associated with a split bearer. In some examples, a UE may receive, from a network node, a configuration associated with mitigating an RLC layer degradation. The UE may detect the RLC layer degradation, which may be based at least in part on an occurrence of an event. The RLC layer degradation may be between a first RLC layer and a second RLC layer that are associated with a split bearer. The event may occur when an RLC RTT difference between the first RLC layer and the second RLC layer satisfies a first threshold. The event may occur when an RLC block error rate (BLER) difference between the first RLC layer and the second RLC layer satisfies a second threshold. The configuration may define one or more parameters for a suspension of the first RLC layer or the second RLC layer. The configuration may define one or more parameters for an SCG deactivation associated with the second RLC layer. The configuration may define one or more conditions for a conditional primary secondary cell (PSCell) addition or change. The UE may perform a corrective action to mitigate the RLC layer degradation based at least in part on the configuration. The UE may suspend the first RLC layer or the second RLC layer based at least in part on the configuration. The UE may perform the SCG deactivation based at least in part on the configuration. The UE may perform the conditional PSCell addition or change based at least in part on the configuration. The UE may transmit, to the network node, an indication of the corrective action taken to mitigate the RLC layer degradation.

Particular aspects of the subject matter described in this disclosure can be implemented to realize one or more of the following potential advantages. In some examples, by configuring the UE to perform the corrective action, the described techniques can be used by the UE to mitigate the RLC layer degradation. The UE may perform an appropriate corrective action (e.g., suspend an RLC layer associated with lag, perform the SCG deactivation, or perform the conditional PSCell addition or change), which may serve to reduce the RLC layer degradation. The UE may perform the appropriate corrective action based at least in part on the configuration from the network node. Otherwise, the RLC layer degradation may continue to persist at the UE, without knowledge of the RLC layer degradation at the UE. In other words, the network node may be unaware of the RLC layer degradation, so the network node may be unable to mitigate the RLC layer degradation. By enabling the UE to perform the corrective action, based at least in part on the configuration from the network node, the RLC layer degradation may be reduced in a timely manner, thereby improving an overall system performance.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

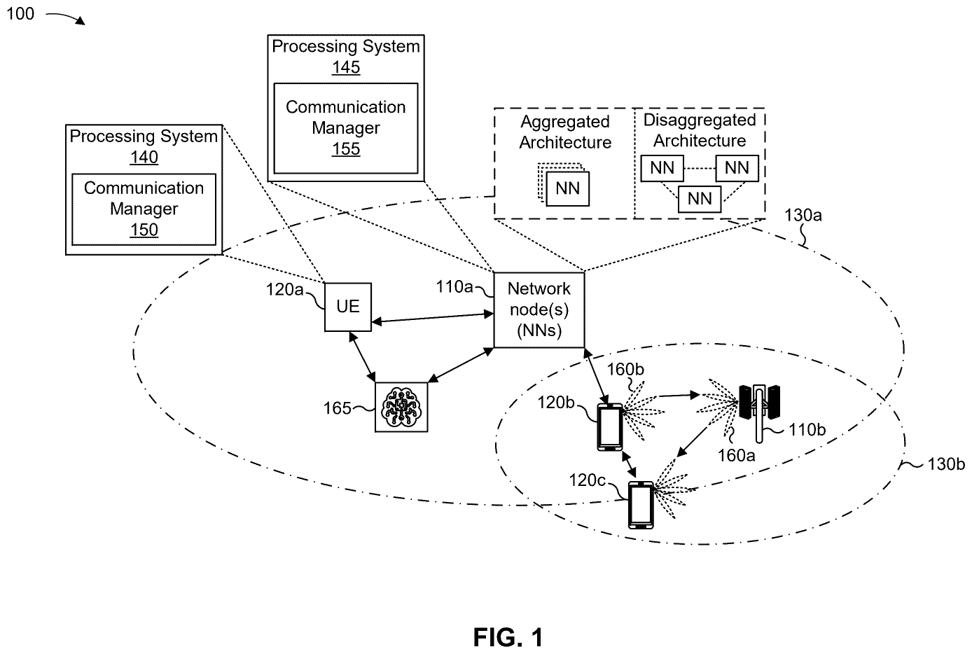

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each

wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

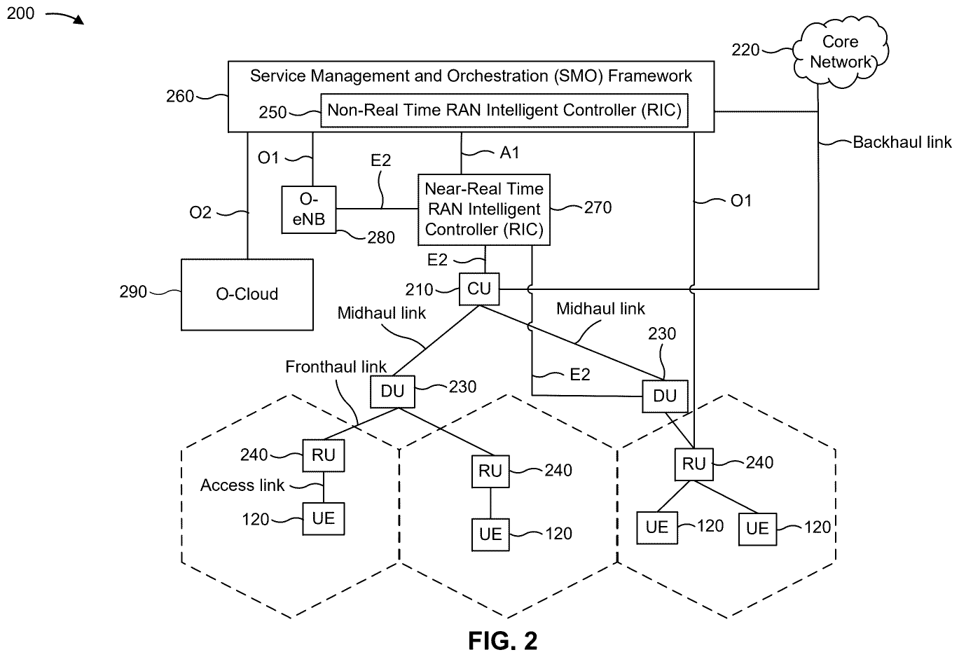

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain

resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be

represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns

or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a UE (e.g., the UE 120) may include a communication manager 150. As described in more detail elsewhere herein, the communication manager 150 may receive a configuration associated with mitigating an RLC layer degradation; detect the RLC layer degradation based at least in part on an occurrence of an event, wherein the RLC layer degradation is between a first RLC layer and a second RLC layer that are associated with a split bearer; and perform a corrective action to mitigate the RLC layer degradation based at least in part on the configuration. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit a configuration associated with mitigating an

RLC layer degradation; and receive an indication of a corrective action performed to mitigate the RLC layer degradation in accordance with the configuration, wherein the RLC layer degradation is detected based at least in part on an occurrence of an event, and wherein the RLC layer degradation is between a first RLC layer and a second RLC layer that are associated with a split bearer. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and

signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data

collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

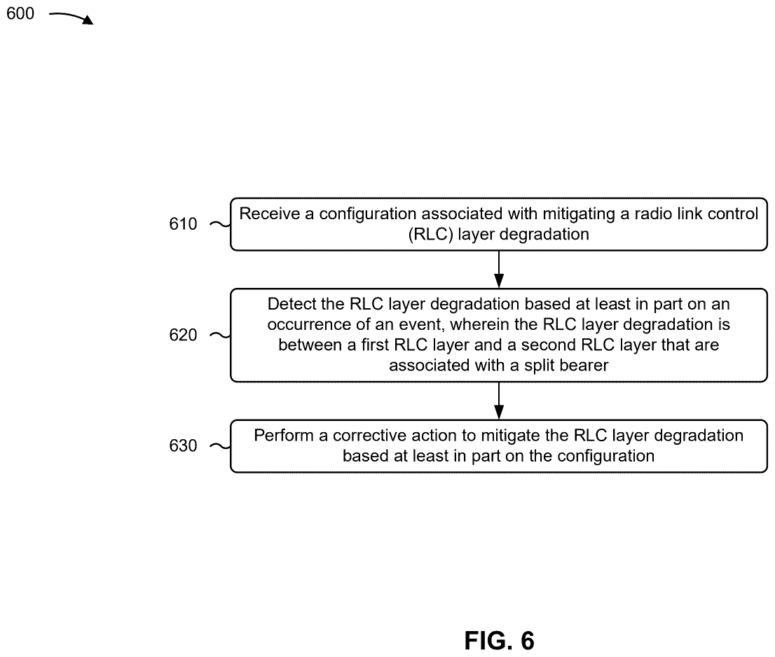

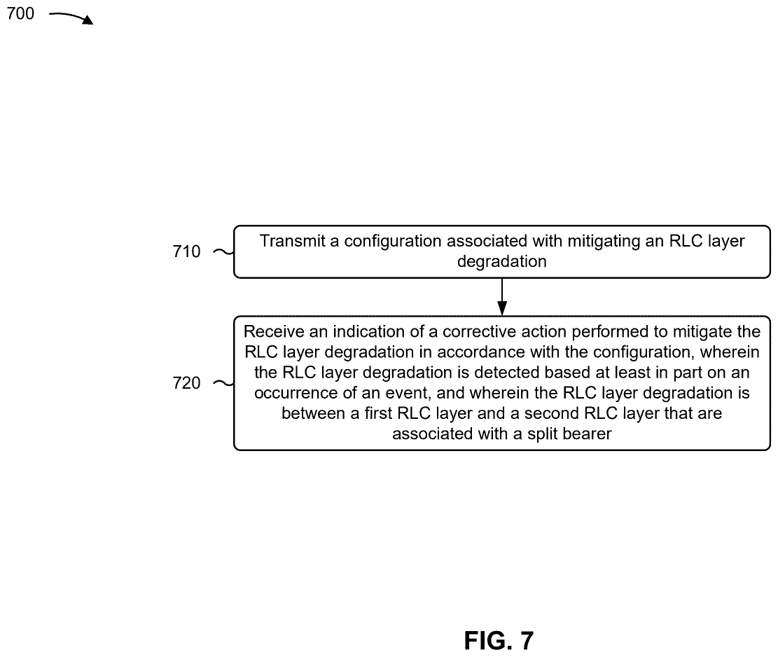

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with mitigating RLC layer degradation associated with a split bearer, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

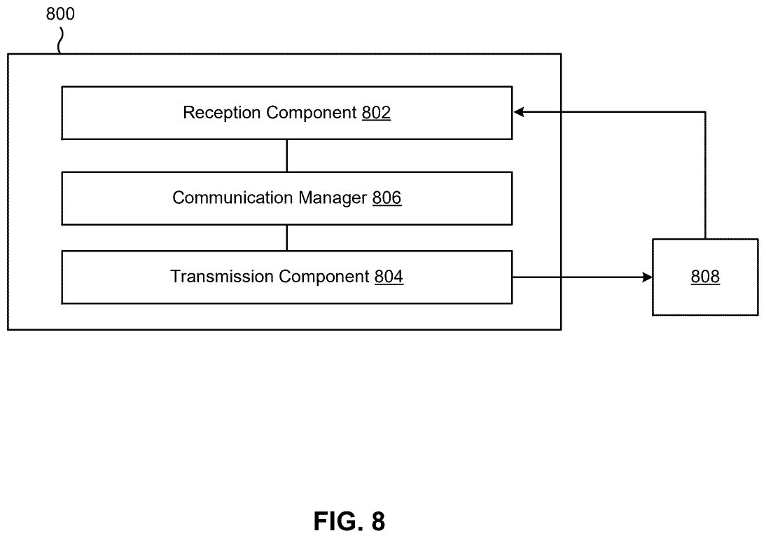

In some aspects, a UE (e.g., the UE 120) includes means for receiving a configuration associated with mitigating an RLC layer degradation; means for detecting the RLC layer degradation based at least in part on an occurrence of an event, wherein the RLC layer degradation is between a first RLC layer and a second RLC layer that are associated with a split bearer; and/or means for performing a corrective action to mitigate the RLC layer degradation based at least in part on the configuration. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

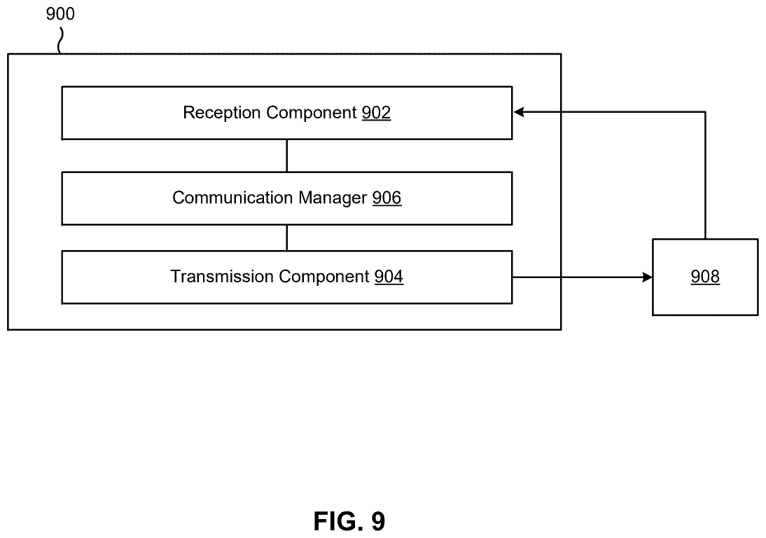

In some aspects, a network node (e.g., the network node 110) includes means for transmitting a configuration associated with mitigating an RLC layer degradation; and/or means for receiving an indication of a corrective action performed to mitigate the RLC layer degradation in accordance with the configuration, wherein the RLC layer degradation is detected based at least in part on an occurrence of an event, and wherein the RLC layer degradation is between a first RLC layer and a second RLC layer that are associated with a split bearer. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

As indicated above, FIG. 2 is provided as an example. Other examples may differ from what is described with regard to FIG. 2.

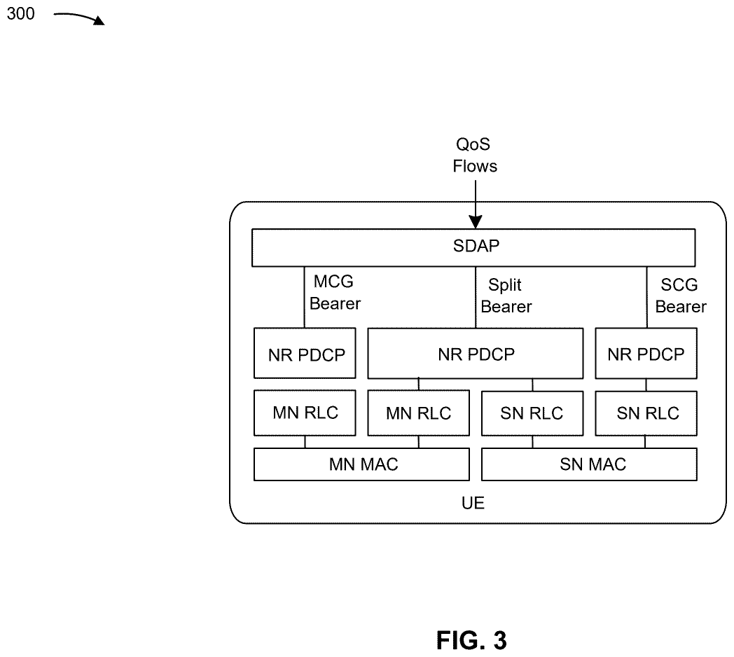

FIG. 3 is a diagram illustrating an example 300 of a radio protocol architecture, in accordance with the present disclosure.

As shown in FIG. 3, a radio protocol architecture for a master cell group (MCG) bearer, an SCG bearer, and a split bearer may be employed at a UE in a multi-radio dual connectivity (MR-DC) with 5G core (5GC). At the UE, a service data adaptation protocol (SDAP) may be associated with the MCG bearer, the SCG bearer, and the split bearer. The MCG bearer may be associated with an NR PDCP layer, a master node (MN) RLC layer, and an MN MAC layer. The MCG bearer may be a radio bearer with an RLC bearer only in an MCG. The MCG may be a group of serving cells associated with an MN. The MN may be a radio access node that provides a control plane connection to a core network. The SCG bearer may be associated with an NR PDCP layer, a secondary node (SN) RLC layer, and an SN MAC layer. The SCG bearer may be a radio bearer with an RLC bearer only in an SCG. The SCG may be a group of serving cells associated with an SN. The SN may be a radio access node with no control plane connection to the core network. The split bearer may be associated with an NR PDCP layer, the MN RLC layer, the SN RLC layer, the MN MAC layer, and the SN MAC layer. The split bearer may be a radio bearer with RLC bearers both in the MCG and the SCG.

As indicated above, FIG. 3 is provided as an example. Other examples may differ from what is described with regard to FIG. 3.

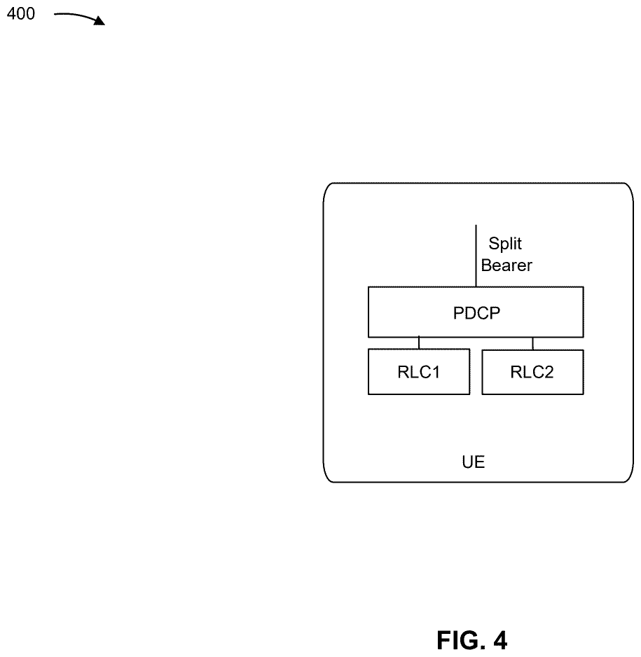

FIG. 4 is a diagram illustrating an example 400 of a split bearer difference, in accordance with the present disclosure.

As shown in FIG. 4, at a UE, a split bearer may be associated with a PDCP layer, where the PDCP layer may be associated with a first RLC (RLC1) layer and a second RLC (RLC2) layer. The first RLC layer may be associated with a first leg and the second RLC layer may be associated with a second leg. In some cases, an RLC RTT difference across the first RLC layer and the second RLC layer may vary. For example, an RLC RTT difference may be higher than 10 ms between the first RLC layer and the second RLC layer. An RLC RTT may be an amount of time for an RLC layer to receive an RLC ACK. The RLC RTT difference may be due to one RLC being associated with a favorable channel condition and another RLC being associated with an unfavorable channel condition. In this case, the first RLC layer may have a low RTT, and the second RLC layer may have a high RTT, which may be especially relevant in FR2 scenarios.

The RLC RTT difference may be resolved using various UE implementations. For example, the UE may adaptively ignore grants associated with an RLC layer with a higher RTT, which may be based at least in part on indicative signals (e.g., HARQ BLER and/or RLC RTT). By ignoring grants associated with the RLC layer with the higher RTT, a load on the RLC layer with the higher RTT may be reduced. As another example, the UE may transmit a zero buffer status report (BSR) on the RLC layer with the higher RTT, which may allow the load on the RLC layer with the higher RTT to be reduced. The RLC RTT difference may also be resolved using modem key performance indicator (KPI) improvements. For example, modem KPI improvements may be employed to reduce an RLC RTT, reduce end-to-end (E2E) latency, and/or reduce a memory consumption used to hold a slower RLC buffer. However, such approaches may not be specification-compliant and may cause a risk of a global certification forum (GCF) violation.

As indicated above, FIG. 4 is provided as an example. Other examples may differ from what is described with regard to FIG. 4.

A network node may depend on a measurement event to deactivate an SCG. For example, an A2 event may occur when a measurement associated with a serving cell becomes worse than an absolute threshold. When the A2 event is detected, the network node may deactivate the SCG. The SCG may be associated with FR2, and an MCG may be associated with FR1. At an SCG cell edge, a coverage may start to become degraded when compared to an MCG mid-cell.

However, an RLC RTT difference across RLC layers at a UE may start to grow significantly, which may impact latency and memory consumption, without triggering the detection of the A2 event. For example, a first RLC layer may be associated with a favorable channel condition (e.g., low RTT) and a second RLC layer may be associated with an unfavorable channel condition (e.g., high RTT), which may cause the RLC RTT difference, but the RLC RTT difference may not necessarily trigger the detection of the A2 event. Without the detection of the A2 event, the SCG may not be deactivated, and the second RLC layer associated with the unfavorable channel condition may continue to be used. Without the detection of the A2 event and without a triggering of an A2 measurement report, the second RLC layer associated with the unfavorable channel condition may not be deactivated in a timely manner. An uplink split threshold may force the UE to transmit data via the second RLC layer associated with the unfavorable channel condition, even when an RLC RTT grows on the second RLC layer, which may cause even more RLC RTT difference across the first RLC layer and the second RLC layer. Existing measurement reports such as A2 may not be sufficient for good split bearer performance. The A2 event may not be triggered while the RLC RTT difference is growing, and/or corrective action may be delayed. For example, a user plane may experience significant degradation before the A2 event is triggered and a behavior is corrected (e.g., releasing the SCG). As a result, the RLC RTT difference across RLC layers may result in an overall degradation in system performance.

In various aspects of techniques and apparatuses described herein, a UE may receive, from a network node, a configuration associated with mitigating an RLC layer degradation. The UE may detect the RLC layer degradation, which may be based at least in part on an occurrence of an event. The RLC layer degradation may be between a first RLC layer and a second RLC layer that are associated with a split bearer. The event may occur when an RLC RTT difference between the first RLC layer and the second RLC layer satisfies a first threshold. The event may occur when an RLC BLER difference between the first RLC layer and the second RLC layer satisfies a second threshold. The event may occur based at least in part on a defined quantity, where the defined quantity may include an RSRP measurement. The configuration may define one or more parameters for a suspension of the first RLC layer or the second RLC layer. The configuration may define one or more parameters for an SCG deactivation associated with the second RLC layer. The configuration may define one or more conditions for a conditional PSCell addition or change. The UE may perform a corrective action to mitigate the RLC layer degradation based at least in part on the configuration. The UE may suspend the first RLC layer or the second RLC layer based at least in part on the configuration. The UE may perform the SCG deactivation based at least in part on the configuration. The UE may perform the conditional PSCell addition or change based at least in part on the configuration. The UE may transmit, to the network node, an indication of the corrective action taken to mitigate the RLC layer degradation.

In some aspects, by configuring the UE to perform the corrective action, the UE may be able to mitigate the RLC layer degradation. The UE may perform an appropriate corrective action (e.g., suspend an RLC layer associated with lag, perform the SCG deactivation, or perform the conditional PSCell addition or change), which may serve to reduce the RLC layer degradation. The UE may perform the appropriate corrective action based at least in part on the configuration from the network node. Otherwise, the RLC layer degradation may continue to persist at the UE, without knowledge of the RLC layer degradation at the UE. In other words, the network node may be unaware of the RLC layer degradation, so the network node may be unable to mitigate the RLC layer degradation. By enabling the UE to perform the corrective action, based at least in part on the configuration from the network node, the RLC layer degradation may be reduced in a timely manner, thereby improving an overall system performance.

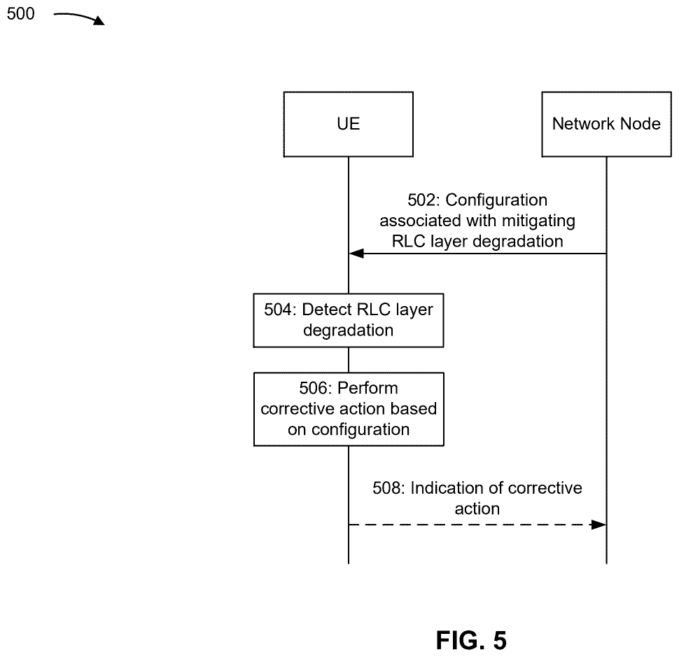

FIG. 5 is a diagram illustrating an example 500 associated with mitigating RLC layer degradation associated with a split bearer, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100.

In some aspects, the UE may be associated with a split bearer. The split bearer may be associated with a first RLC layer and a second RLC layer. The first RLC layer may be associated with an MCG, and the second RLC layer may be associated with an SCG. The first RLC layer may be associated with a first channel condition and the second RLC layer may be associated with a second channel condition. The first channel condition may correspond to the second channel condition, or alternatively, the first channel condition may not correspond to the second channel condition.

As shown by reference number 502, the UE may receive (e.g., using reception component 802 and/or communication manager 806, depicted in FIG. 8), from the network node, a configuration associated with mitigating an RLC layer degradation. The configuration may be an RRC configuration that defines one or more conditions associated with performing a corrective action to mitigate the RLC layer degradation. The configuration may be an AI native configuration that allows a predictive model to run with one or more boundary conditions on UE behavior.

In some aspects, the configuration may define one or more parameters for a suspension of the first RLC layer or the second RLC layer based at least in part on the RLC layer degradation being an observed RLC layer degradation. The configuration may indicate an RLC RTT difference threshold, an RLC BLER difference threshold, and/or a suspension duration. The suspension duration may be a suspension parameter to be applied by the UE, rather than a condition for suspension. The configuration may define one or more parameters for autonomously suspending the first RLC layer or the second RLC layer based at least in part on the RLC layer degradation being a predicted RLC layer degradation. The configuration may include a range configuration. The range configuration may indicate a minimum RLC RTT for the UE to suspend the first RLC layer or the second RLC layer, a maximum RLC RTT for the UE to suspend the first RLC layer or the second RLC layer, a minimum RLC BLER for the UE to suspend the first RLC layer or the second RLC layer, a maximum RLC BLER for the UE to suspend the first RLC layer or the second RLC layer, a number of grants that the UE is allowed to miss over a time window due to an RLC layer suspension, a maximum time that the UE is able to suspend the first RLC layer or the second RLC layer, and/or a minimum time that the UE is to wait between two RLC layer suspensions. The configuration may include a KPI configuration. The KPI configuration may indicate a KPI on a throughput on the first RLC layer and the second RLC layer, and/or a KPI on an observed RTT or BLER based at least in part on an autonomous UE behavior.

In some aspects, the configuration may define one or more parameters for an SCG deactivation associated with the second RLC layer. The configuration may indicate a counter and/or a timer, where the SCG deactivation may be based at least in part on the counter and/or the timer. The UE may perform a PDCP layer data recovery via an MCG based at least in part on the SCG deactivation. In some aspects, the UE may receive, from the network node, an indication of an uplink data split threshold. Alternatively, the UE may autonomously set the uplink data split threshold. The uplink data split threshold may be adjusted after the SCG deactivation to prioritize the first RLC layer or the second RLC layer. In some aspects, the configuration may define one or more conditions for a conditional PSCell addition or change. The one or more conditions may include an RLC RTT or BLER difference condition.

As shown by reference number 504, the UE may detect (e.g., using communication manager 806, depicted in FIG. 8) the RLC layer degradation based at least in part on an occurrence of an event, where the RLC layer degradation may be between a first RLC layer and a second RLC layer that are associated with a split bearer. The event may occur when an RLC RTT difference between the first RLC layer and the second RLC layer satisfies a first threshold. The event may occur when an RLC BLER difference between the first RLC layer and the second RLC layer satisfies a second threshold. The event may occur based at least in part on a defined quantity, where the defined quantity may include an RSRP measurement. In some aspects, the UE may receive, from the network, a configuration that indicates one or more events, and the UE may detect whether one of the events occurs based at least in part on the configuration.

As shown by reference number 506, the UE may perform (e.g., using communication manager 806, depicted in FIG. 8) a corrective action to mitigate the RLC layer degradation based at least in part on the configuration. The UE, when performing the corrective action, may temporarily suspend the first RLC layer or the second RLC layer based at least in part on the configuration. The UE, when performing the corrective action, may autonomously suspend the first RLC layer or the second RLC layer based at least in part on the configuration. The UE may complete pending retransmissions prior to temporarily suspending the first RLC layer or the second RLC layer. Alternatively, the UE may discard all pending retransmissions prior to temporarily suspending the first RLC layer or the second RLC layer, and then the UE may attempt to retransmit the pending retransmissions via the first RLC layer or the second RLC layer. The UE, when performing the corrective action, may perform the SCG deactivation based at least in part on the configuration. The UE, when performing the corrective action, may perform the conditional PSCell addition or change based at least in part on the configuration. The UE may perform the conditional PSCell addition or change based at least in part on the RLC RTT or BLER difference condition being satisfied.

In some aspects, the UE may detect the RLC layer degradation (e.g., an RLC leg degradation). The UE may detect the RLC layer degradation of the first RLC layer in relation to the second RLC layer, or the RLC layer degradation of the second RLC layer in relation to the first RLC layer. The UE may detect the RLC layer degradation based at least in part on the occurrence of the event. The UE may be configured with the event via RRC signaling, which may be used to detect the RLC layer degradation, and which may trigger the corrective action to be taken by the UE to mitigate the RLC layer degradation. Types of corrective actions that are available for the UE to take may be configured by the network node.

In some aspects, the UE may perform one or more measurements between the first RLC layer and the second RLC layer, and when the one or more measurements cause the event to be satisfied, the UE may perform the correction action. For example, the event may occur when the RLC RTT difference across the first RLC layer and the second RLC layer (e.g., an RLC RTT difference across RLC legs) satisfies a configured threshold, which may trigger the UE to perform the corrective action. In other words, the UE may measure the RLC RTT difference across the first RLC layer and the second RLC layer, and when the RLC RTT difference satisfies the configured threshold, the event may be satisfied, which means that the RLC layer degradation is present and the UE may take the corrective action. As another example, the event may occur when the RLC BLER difference across the first RLC layer and the second RLC layer (e.g., an RLC BLER difference across RLC legs) satisfies a configured threshold, which may trigger the UE to perform the corrective action. In other words, the UE may measure the RLC BLER difference across the first RLC layer and the second RLC layer, and when the RLC BLER difference satisfies the configured threshold, the event may occur, which means that the RLC layer degradation is present and the UE may take the corrective action.

In some aspects, the UE may detect and/or predict the RLC layer degradation, which may be based at least in part on the RLC RTT and/or BLER (RTT/BLER) difference between the first RLC layer and the second RLC layer. The UE may detect and/or predict the RLC layer degradation based at least in part on other user plane measurements across the first RLC layer and the second RLC layer, which may include HARQ BLER difference measurements across the first RLC layer and the second RLC layer. The UE may detect and/or predict the RLC layer degradation based at least in part on one or more standard predefinitions and/or an RRC configuration from the network. The UE may report the RLC layer degradation to the network node.

In some aspects, the corrective actions that are available to the UE may be configured by the network node. The network node may configure the UE to temporarily suspend one RLC layer when the RLC layer degradation is detected. The network node may configure the UE to deactivate the SCG (e.g., deactivate the second RLC layer associated with the SCG) when the RLC layer degradation is detected. The network node may configure the UE to perform a conditional PSCell addition or change when the RLC layer degradation is detected. The network node may transmit a configuration (e.g., an RRC configuration) that indicates one or more conditions, which may allow the UE to perform the corrective actions when the RLC layer degradation is detected. Alternatively, the network node may transmit an AI native configuration, which may allow the UE to run a predictive model. The UE may use the predictive model when determining whether to take the corrective actions and/or which specific corrective action to take. The AI native configuration may define certain boundary conditions on UE behavior (e.g., minimum and/or maximum thresholds), which may guide the predictive model when the predictive model is being used for determining the corrective actions.

In some aspects, the UE may temporarily suspend the first RLC layer or the second RLC layer (e.g., a lagging RLC leg) based at least in part on an observed or predicted RLC RTT/BLER difference between the first RLC layer and the second RLC layer. The UE may temporarily suspend the first RLC layer, which may be associated with the MCG (e.g., the first RLC layer may be associated with a primary leg). The UE may temporarily suspend the second RLC layer, which may be associated with the SCG (e.g., the second RLC may be associated with a secondary leg).

In some aspects, the network node may configure an RLC layer suspension behavior of the UE via RRC signaling, where the RLC layer suspension behavior may be based at least in part on an observed RLC RTT/BLER difference. A configuration from the network node may indicate an RTT/BLER difference threshold, which may indicate a difference of RLC RTT/BLER (or any other relevant user plane quantity) across the first RLC layer and the second RLC layer. The configuration may indicate a suspension duration, which may define an amount of time that the UE should suspend the first RLC layer or the second RLC layer (e.g., via a configured timer). The configuration may indicate other conditions (e.g., conditions in terms of RRM measurements to apply during the suspension).

In some aspects, the network node may configure an autonomous RLC layer suspension behavior of the UE, where the autonomous RLC layer suspension behavior may be based at least in part on a predicted RLC RTT/BLER difference. A configuration of such UE autonomous behavior may be based at least in part on an AI-native user plane configuration. The UE autonomous behavior may be allowed based at least in part on conditions configured by the network node, where the conditions may include range and/or KPI. In some aspects, the range configuration may indicate a minimum/maximum RLC RTT parameter, which may define a minimum/maximum allowed RTT for the UE to autonomously suspend an RLC layer (e.g., the first RLC layer or the second RLC layer). The range configuration may indicate a minimum/maximum BLER parameter, which may define a minimum/maximum RLC/HARQ BLER for the UE to autonomously suspend an RLC layer. The range configuration may indicate a missed grants parameter, which may define an amount of grants (or cumulative grant size in bytes) that the UE is allowed to miss over a certain time window due to an RLC layer suspension. The range configuration may indicate a maximum suspension time parameter, which may define a maximum time that the UE is able to suspend an RLC layer. The range configuration may indicate a suspension prohibit time parameter, which may define a minimum time that the UE should wait between two RLC layer suspensions. In some aspects, the KPI configuration may indicate a throughput parameter, which may correspond to a KPI on a supported throughput on both RLC layers. The KPI configuration may indicate an RTT parameter, which may correspond to a KPI on an observed RTT based at least in part on the autonomous UE behavior.

In some aspects, the UE may notify the network node of a suspended RLC layer. The UE may transmit such a notification via a MAC-CE, PDCP control signaling, RLC control signaling, UCI (e.g., a special CSI report), or RRC signaling (e.g., UE assistance information (UAI)). In some aspects, ongoing retransmissions may be present in an RLC layer before temporary suspension. In order to achieve data continuity, the UE may complete all pending retransmissions before suspending the RLC layer. Alternatively, the UE may discard all pending retransmissions, send a discard indication to the network node, and attempt to transmit unacknowledged service data units (SDUs) via the other RLC layer.

In some aspects, in the SCG deactivation, which may be associated with power savings, the UE may not monitor a PDCCH on a PSCell, one or more SCG secondary cells (SCells) may be deactivated, and/or the UE may not transmit an SRS, a PUSCH transmission, or a PUCCH transmission on an SCG uplink. In some aspects, the SCG deactivation may be allowed based at least in part on an RLC RTT/BLER measurement configuration, which may be based at least in part on an RRC configuration. The UE may request the SCG deactivation based at least in part on configured RLC RTT/BLER measurements across RLC layers. When the SCG is deactivated, an RRC UE assistance information message may be transmitted via the MCG.

In some aspects, the network node may configure the counter and/or the timer, which may be used to trigger the SCG deactivation depending on a measured RLC RTT/BLER difference. A configuration may indicate the counter, which may define a number of times that the UE should record the RLC RTT/BLER difference exceeding a threshold within the timer. The timer may run when the RLC RTT/BLER difference exceeds the threshold for the first time. The timer may stop when the RLC RTT/BLER difference falls below the threshold. When the timer expires and the RLC RTT/BLER difference has not fallen below the threshold, the UE may transmit an SCG deactivation request, or a radio link failure (RLF) may be declared on the SCG.

In some aspects, when the SCG is deactivated, the UE may perform the PDCP layer data recovery via the MCG. In some aspects, after the SCG deactivation, the uplink data split threshold may be changed at the UE. The uplink data split threshold may define a manner in which data is split between the first RLC layer and the second RLC layer. In a first option, the network node may signal that for an uplink split data ratio bearer (DRB), only the first RLC layer associated with the MCG (e.g., only an MCG path) may be used. For example, the uplink data split threshold may be set to infinity, such that no data is then submitted to the second RLC layer associated with the SCG. In a second option, the UE may autonomously set the uplink data split threshold to a new value. For example, the UE may set the uplink data split threshold to infinity to prioritize the first RLC layer associated with the MCG (e.g., the MCG path), or the UE may set the uplink data split threshold to zero to prioritize the second RLC layer associated with the SCG (e.g., the SCG path).

In some aspects, the conditional PSCell addition or change may allow for changes on the PSCell. Execution conditions for the conditional PSCell addition or change may be based at least in part on different events (e.g., A4/B1 events) and measurement thresholds. In some aspects, an RLC RTT/BLER difference condition may be defined in a conditional PSCell addition or change RRC configuration. The UE may check the RLC RTT/BLER difference condition, and when the RLC RTT/BLER difference condition is satisfied, the UE may perform a configured conditional PSCell addition or change procedure. The UE may use user plane measurements (e.g., the RLC RTT/BLER difference between the first RLC layer and the second RLC layer) to trigger the conditional PSCell addition or change. In some aspects, the RLC RTT/BLER difference condition may be paired with another RSRP, RSRQ, and/or signal-to-noise ratio (SNR) measurement. For example, the UE may perform the conditional PSCell addition or change when both the RLC RTT/BLER difference condition and an event (e.g., event A3/A4/A5/B1) are satisfied.

As shown by reference number 508, the UE may transmit, to the network node, an indication of the corrective action taken to mitigate the RLC layer degradation. The UE may indicate that the UE suspended the first RLC layer or the second RLC layer. The UE may indicate that the UE performed the SCG deactivation. The UE may indicate that the UE performed the conditional PSCell addition or change. As a result, the network node may be notified of the corrective action taken by the UE. The network node may perform additional corrective actions, such as corrective actions that were not taken by the UE, in order to further mitigate the RLC layer degradation.

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with mitigating RLC layer degradation associated with a split bearer.

As shown in FIG. 6, in some aspects, process 600 may include receiving a configuration associated with mitigating an RLC layer degradation (block 610). For example, the UE (e.g., using reception component 802 and/or communication manager 806, depicted in FIG. 8) may receive a configuration associated with mitigating an RLC layer degradation, as described above in connection with reference number 502 in FIG. 5.

As further shown in FIG. 6, in some aspects, process 600 may include detecting the RLC layer degradation based at least in part on an occurrence of an event, wherein the RLC layer degradation is between a first RLC layer and a second RLC layer that are associated with a split bearer (block 620). For example, the UE (e.g., using communication manager 806, depicted in FIG. 8) may detect the RLC layer degradation based at least in part on an occurrence of an event, wherein the RLC layer degradation is between a first RLC layer and a second RLC layer that are associated with a split bearer, as described above in connection with reference number 504 in FIG. 5.

As further shown in FIG. 6, in some aspects, process 600 may include performing a corrective action to mitigate the RLC layer degradation based at least in part on the configuration (block 630). For example, the UE (e.g., using communication manager 806, depicted in FIG. 8) may perform a corrective action to mitigate the RLC layer degradation based at least in part on the configuration, as described above in connection with reference number 506 in FIG. 5.

Process 600 may include additional aspects, such as any single aspect or any combination of aspects described below and/or in connection with one or more other processes described elsewhere herein.

In a first aspect, the event occurs when an RLC RTT difference between the first RLC layer and the second RLC layer satisfies a first threshold, the event occurs when an RLC BLER difference between the first RLC layer and the second RLC layer satisfies a second threshold, or the event occurs based at least in part on a defined quantity, where the defined quantity includes an RSRP measurement.

In a second aspect, alone or in combination with the first aspect, the configuration is an RRC configuration that defines one or more conditions associated with performing the corrective action, or the configuration allows a predictive model to run with one or more boundary conditions on UE behavior.

In a third aspect, alone or in combination with one or more of the first and second aspects, the configuration defines one or more parameters for a suspension of the first RLC layer or the second RLC layer based at least in part on the RLC layer degradation being an observed RLC layer degradation, and process 600 includes suspending the first RLC layer or the second RLC layer based at least in part on the configuration.

In a fourth aspect, alone or in combination with one or more of the first through third aspects, the configuration indicates one or more of an RLC RTT difference threshold, an RLC BLER difference threshold, or a suspension duration to be applied by the UE.

In a fifth aspect, alone or in combination with one or more of the first through fourth aspects, the configuration defines one or more parameters for autonomously suspending the first RLC layer or the second RLC layer based at least in part on the RLC layer degradation being a predicted RLC layer degradation, and process 600 includes autonomously suspending the first RLC layer or the second RLC layer based at least in part on the configuration.

In a sixth aspect, alone or in combination with one or more of the first through fifth aspects, the configuration includes a range configuration, and the range configuration indicates one or more of a minimum RLC RTT for the UE to suspend the first RLC layer or the second RLC layer, a maximum RLC RTT for the UE to suspend the first RLC layer or the second RLC layer, a minimum RLC BLER for the UE to suspend the first RLC layer or the second RLC layer, a maximum RLC BLER for the UE to suspend the first RLC layer or the second RLC layer, a number of grants that the UE is allowed to miss over a time window due to an RLC layer suspension, a maximum time that the UE is able to suspend the first RLC layer or the second RLC layer, or a minimum time that the UE is to wait between two RLC layer suspensions.

In a seventh aspect, alone or in combination with one or more of the first through sixth aspects, the configuration includes a KPI configuration, and the KPI configuration indicates one or more of a KPI on a throughput on the first RLC layer and the second RLC layer, or a KPI on an observed RTT or BLER based at least in part on an autonomous UE behavior.

In an eighth aspect, alone or in combination with one or more of the first through seventh aspects, process 600 includes transmitting an indication of the corrective action taken to mitigate the RLC layer degradation.

In a ninth aspect, alone or in combination with one or more of the first through eighth aspects, the corrective action includes temporarily suspending the first RLC layer or the second RLC layer, and process 600 includes completing pending retransmissions prior to temporarily suspending the first RLC layer or the second RLC layer, or discarding all pending retransmissions prior to temporarily suspending the first RLC layer or the second RLC layer, and attempting to retransmit the pending retransmissions via the first RLC layer or the second RLC layer.

In a tenth aspect, alone or in combination with one or more of the first through ninth aspects, the configuration defines one or more parameters for an SCG deactivation associated with the second RLC layer, and process 600 includes performing the SCG deactivation based at least in part on the configuration.

In an eleventh aspect, alone or in combination with one or more of the first through tenth aspects, the configuration indicates one or more of a counter or a timer, and the SCG deactivation is based at least in part on one or more of the counter or the timer.

In a twelfth aspect, alone or in combination with one or more of the first through eleventh aspects, a PDCP layer data recovery is via an MCG based at least in part on the SCG deactivation.

In a thirteenth aspect, alone or in combination with one or more of the first through twelfth aspects, process 600 includes receiving an indication of an uplink data split threshold, or autonomously setting the uplink data split threshold, wherein the uplink data split threshold is adjusted after the SCG deactivation to prioritize the first RLC layer or the second RLC layer.

In a fourteenth aspect, alone or in combination with one or more of the first through thirteenth aspects, the configuration defines one or more conditions for a conditional PSCell addition or change, and process 600 includes performing the conditional PSCell addition or change based at least in part on the configuration.

In a fifteenth aspect, alone or in combination with one or more of the first through fourteenth aspects, the one or more conditions includes an RLC RTT or BLER difference condition, and the conditional PSCell addition or change is performed based at least in part on the RLC RTT or BLER difference condition being satisfied.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with mitigating RLC layer degradation associated with a split bearer.

As shown in FIG. 7, in some aspects, process 700 may include transmitting a configuration associated with mitigating an RLC layer degradation (block 710). For example, the network node (e.g., using transmission component 904 and/or communication manager 906, depicted in FIG. 9) may transmit a configuration associated with mitigating an RLC layer degradation, as described above in connection with reference number 502 in FIG. 5.

As further shown in FIG. 7, in some aspects, process 700 may include receiving an indication of a corrective action performed to mitigate the RLC layer degradation in accordance with the configuration, wherein the RLC layer degradation is detected based at least in part on an occurrence of an event, and wherein the RLC layer degradation is between a first RLC layer and a second RLC layer that are associated with a split bearer (block 720). For example, the network node (e.g., using reception component 902 and/or communication manager 906, depicted in FIG. 9) may receive an indication of a corrective action performed to mitigate the RLC layer degradation in accordance with the configuration, wherein the RLC layer degradation is detected based at least in part on an occurrence of an event, and wherein the RLC layer degradation is between a first RLC layer and a second RLC layer that are associated with a split bearer, as described above in connection with reference number 508 in FIG. 5.

Process 700 may include additional aspects, such as any single aspect or any combination of aspects described below and/or in connection with one or more other processes described elsewhere herein.

In a first aspect, the event occurs when an RLC RTT difference between the first RLC layer and the second RLC layer satisfies a first threshold, the event occurs when an RLC BLER difference between the first RLC layer and the second RLC layer satisfies a second threshold, or the event occurs based at least in part on a defined quantity, where the defined quantity includes an RSRP measurement.

In a second aspect, alone or in combination with the first aspect, the configuration is an RRC configuration that defines one or more conditions associated with the corrective action, or the configuration allows a predictive model to run with one or more boundary conditions on UE behavior.

In a third aspect, alone or in combination with one or more of the first and second aspects, the configuration defines one or more parameters for a suspension of the first RLC layer or the second RLC layer based at least in part on the RLC layer degradation being an observed RLC layer degradation, and the corrective action includes the suspension of the first RLC layer or the second RLC layer based at least in part on the configuration.

In a fourth aspect, alone or in combination with one or more of the first through third aspects, the configuration indicates one or more of an RLC RTT difference threshold, an RLC BLER difference threshold, or a suspension duration to be applied by the UE.

In a fifth aspect, alone or in combination with one or more of the first through fourth aspects, the configuration defines one or more parameters for an autonomous suspension of the first RLC layer or the second RLC layer based at least in part on the RLC layer degradation being a predicted RLC layer degradation, and the corrective action includes the autonomous suspension of the first RLC layer or the second RLC layer based at least in part on the configuration.

In a sixth aspect, alone or in combination with one or more of the first through fifth aspects, the configuration includes a range configuration, and the range configuration indicates one or more of a minimum RLC RTT for UE to suspend the first RLC layer or the second RLC layer, a maximum RLC RTT for the UE to suspend the first RLC layer or the second RLC layer, a minimum RLC BLER for the UE to suspend the first RLC layer or the second RLC layer, a maximum RLC BLER for the UE to suspend the first RLC layer or the second RLC layer, a number of grants that the UE is allowed to miss over a time window due to an RLC layer suspension, a maximum time that the UE is able to suspend the first RLC layer or the second RLC layer, or a minimum time that the UE is to wait between two RLC layer suspensions.

In a seventh aspect, alone or in combination with one or more of the first through sixth aspects, the configuration includes a KPI configuration, and the KPI configuration indicates one or more of a KPI on a throughput on the first RLC layer and the second RLC layer, or a KPI on an observed RTT or BLER based at least in part on an autonomous UE behavior.

In an eighth aspect, alone or in combination with one or more of the first through seventh aspects, the configuration defines one or more parameters for an SCG deactivation associated with the second RLC layer, and the corrective action includes the SCG deactivation based at least in part on the configuration.

In a ninth aspect, alone or in combination with one or more of the first through eighth aspects, the configuration indicates one or more of a counter or a timer, and the SCG deactivation is based at least in part on one or more of the counter or the timer.

In a tenth aspect, alone or in combination with one or more of the first through ninth aspects, a PDCP layer data recovery is via an MCG based at least in part on the SCG deactivation.

In an eleventh aspect, alone or in combination with one or more of the first through tenth aspects, process 700 includes transmitting an indication of an uplink data split threshold, wherein the uplink data split threshold is adjusted after the SCG deactivation to prioritize the first RLC layer or the second RLC layer.

In a twelfth aspect, alone or in combination with one or more of the first through eleventh aspects, the configuration defines one or more conditions for a conditional PSCell addition or change, and the corrective action includes the conditional PSCell addition or change based at least in part on the configuration.

In a thirteenth aspect, alone or in combination with one or more of the first through twelfth aspects, the one or more conditions includes an RLC RTT or BLER difference condition, and the conditional PSCell addition or change is based at least in part on the RLC RTT or BLER difference condition being satisfied.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive a configuration associated with mitigating an RLC layer degradation. The communication manager 806 may detect the RLC layer degradation based at least in part on an occurrence of an event, wherein the RLC layer degradation is between a first RLC layer and a second RLC layer that are associated with a split bearer. The communication manager 806 may perform a corrective action to mitigate the RLC layer degradation based at least in part on the configuration. The transmission component 804 may transmit an indication of the corrective action taken to mitigate the RLC layer degradation.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit a configuration associated with mitigating an RLC layer degradation. The reception component 902 may receive an indication of a corrective action performed to mitigate the RLC layer degradation in accordance with the configuration, wherein the RLC layer degradation is detected based at least in part on an occurrence of an event, and wherein the RLC layer degradation is between a first RLC layer and a second RLC layer that are associated with a split bearer.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving a configuration associated with mitigating a radio link control (RLC) layer degradation; detecting the RLC layer degradation based at least in part on an occurrence of an event, wherein the RLC layer degradation is between a first RLC layer and a second RLC layer that are associated with a split bearer; and performing a corrective action to mitigate the RLC layer degradation based at least in part on the configuration.
Aspect 2: The method of Aspect 1, wherein: the event occurs when an RLC round trip time difference between the first RLC layer and the second RLC layer satisfies a first threshold; the event occurs when an RLC block error rate difference between the first RLC layer and the second RLC layer satisfies a second threshold; or the event occurs based at least in part on a defined quantity, where the defined quantity includes a reference signal received power measurement.
Aspect 3: The method of any of Aspects 1-2, wherein the configuration is a radio resource control configuration that defines one or more conditions associated with performing the corrective action, or the configuration allows a predictive model to run with one or more boundary conditions on UE behavior.
Aspect 4: The method of any of Aspects 1-3, wherein the configuration defines one or more parameters for a suspension of the first RLC layer or the second RLC layer based at least in part on the RLC layer degradation being an observed RLC layer degradation, and wherein performing the corrective action includes suspending the first RLC layer or the second RLC layer based at least in part on the configuration.
Aspect 5: The method of Aspect 4, wherein the configuration indicates one or more of: an RLC round trip time difference threshold, an RLC block error rate difference threshold, or a suspension duration to be applied by the UE.
Aspect 6: The method of any of Aspects 1-5, wherein the configuration defines one or more parameters for autonomously suspending the first RLC layer or the second RLC layer based at least in part on the RLC layer degradation being a predicted RLC layer degradation, and wherein performing the corrective action includes autonomously suspending the first RLC layer or the second RLC layer based at least in part on the configuration.
Aspect 7: The method of Aspect 6, wherein the configuration includes a range configuration, and wherein the range configuration indicates one or more of: a minimum RLC roundtrip time (RTT) for the UE to suspend the first RLC layer or the second RLC layer, a maximum RLC RTT for the UE to suspend the first RLC layer or the second RLC layer, a minimum RLC block error rate (BLER) for the UE to suspend the first RLC layer or the second RLC layer, a maximum RLC BLER for the UE to suspend the first RLC layer or the second RLC layer, a number of grants that the UE is allowed to miss over a time window due to an RLC layer suspension, a maximum time that the UE is able to suspend the first RLC layer or the second RLC layer, or a minimum time that the UE is to wait between two RLC layer suspensions.
Aspect 8: The method of Aspect 6, wherein the configuration includes a key performance indicator (KPI) configuration, and wherein the KPI configuration indicates one or more of: a KPI on a throughput on the first RLC layer and the second RLC layer, or a KPI on an observed roundtrip time or block error rate based at least in part on an autonomous UE behavior.
Aspect 9: The method of any of Aspects 1-8, further comprising: transmitting an indication of the corrective action taken to mitigate the RLC layer degradation.
Aspect 10: The method of any of Aspects 1-9, wherein the corrective action includes temporarily suspending the first RLC layer or the second RLC layer, and further comprising: completing pending retransmissions prior to temporarily suspending the first RLC layer or the second RLC layer; or discarding all pending retransmissions prior to temporarily suspending the first RLC layer or the second RLC layer, and attempting to retransmit the pending retransmissions via the first RLC layer or the second RLC layer.
Aspect 11: The method of any of Aspects 1-10, wherein the configuration defines one or more parameters for a secondary cell group (SCG) deactivation associated with the second RLC layer, and wherein performing the corrective action includes performing the SCG deactivation based at least in part on the configuration.
Aspect 12: The method of Aspect 11, wherein the configuration indicates one or more of a counter or a timer, and wherein the SCG deactivation is based at least in part on one or more of the counter or the timer.
Aspect 13: The method of Aspect 11, wherein a packet data convergence protocol layer data recovery is via a master cell group based at least in part on the SCG deactivation.
Aspect 14: The method of Aspect 11, further comprising: receiving an indication of an uplink data split threshold; or autonomously setting the uplink data split threshold, wherein the uplink data split threshold is adjusted after the SCG deactivation to prioritize the first RLC layer or the second RLC layer.
Aspect 15: The method of any of Aspects 1-14, wherein the configuration defines one or more conditions for a conditional primary secondary cell (PSCell) addition or change, and wherein performing the corrective action includes performing the conditional PSCell addition or change based at least in part on the configuration.
Aspect 16: The method of Aspect 15, wherein the one or more conditions includes an RLC roundtrip time (RTT) or block error rate (BLER) difference condition, and wherein the conditional PSCell addition or change is performed based at least in part on the RLC RTT or BLER difference condition being satisfied.
Aspect 17: A method of wireless communication performed by a network node, comprising: transmitting a configuration associated with mitigating a radio link control (RLC) layer degradation; and receiving an indication of a corrective action performed to mitigate the RLC layer degradation in accordance with the configuration, wherein the RLC layer degradation is detected based at least in part on an occurrence of an event, and wherein the RLC layer degradation is between a first RLC layer and a second RLC layer that are associated with a split bearer.
Aspect 18: The method of Aspect 17, wherein: the event occurs when an RLC round trip time difference between the first RLC layer and the second RLC layer satisfies a first threshold; the event occurs when an RLC block error rate difference between the first RLC layer and the second RLC layer satisfies a second threshold; or the event occurs based at least in part on a defined quantity, where the defined quantity includes a reference signal received power measurement.
Aspect 19: The method of any of Aspects 17-18, wherein the configuration is a radio resource control configuration that defines one or more conditions associated with the corrective action, or the configuration allows a predictive model to run with one or more boundary conditions on user equipment behavior.
Aspect 20: The method of any of Aspects 17-19, wherein the configuration defines one or more parameters for a suspension of the first RLC layer or the second RLC layer based at least in part on the RLC layer degradation being an observed RLC layer degradation, and wherein the corrective action includes the suspension of the first RLC layer or the second RLC layer based at least in part on the configuration.
Aspect 21: The method of Aspect 20, wherein the configuration indicates one or more of: an RLC round trip time difference threshold, an RLC block error rate difference threshold, or a suspension duration to be applied by a user equipment.
Aspect 22: The method of any of Aspects 17-21, wherein the configuration defines one or more parameters for an autonomous suspension of the first RLC layer or the second RLC layer based at least in part on the RLC layer degradation being a predicted RLC layer degradation, and wherein the corrective action includes the autonomous suspension of the first RLC layer or the second RLC layer based at least in part on the configuration.
Aspect 23: The method of Aspect 22, wherein the configuration includes a range configuration, and wherein the range configuration indicates one or more of: a minimum RLC roundtrip time (RTT) for a user equipment (UE) to suspend the first RLC layer or the second RLC layer, a maximum RLC RTT for the UE to suspend the first RLC layer or the second RLC layer, a minimum RLC block error rate (BLER) for the UE to suspend the first RLC layer or the second RLC layer, a maximum RLC BLER for the UE to suspend the first RLC layer or the second RLC layer, a number of grants that the UE is allowed to miss over a time window due to an RLC layer suspension, a maximum time that the UE is able to suspend the first RLC layer or the second RLC layer, or a minimum time that the UE is to wait between two RLC layer suspensions.
Aspect 24: The method of Aspect 22, wherein the configuration includes a key performance indicator (KPI) configuration, and wherein the KPI configuration indicates one or more of: a KPI on a throughput on the first RLC layer and the second RLC layer, or a KPI on an observed roundtrip time or block error rate based at least in part on an autonomous user equipment behavior.
Aspect 25: The method of any of Aspects 17-24, wherein the configuration defines one or more parameters for a secondary cell group (SCG) deactivation associated with the second RLC layer, and wherein the corrective action includes the SCG deactivation based at least in part on the configuration.
Aspect 26: The method of Aspect 25, wherein the configuration indicates one or more of a counter or a timer, and wherein the SCG deactivation is based at least in part on one or more of the counter or the timer.
Aspect 27: The method of Aspect 25, wherein a packet data convergence protocol layer data recovery is via a master cell group based at least in part on the SCG deactivation.
Aspect 28: The method of Aspect 25, further comprising: transmitting an indication of an uplink data split threshold, wherein the uplink data split threshold is adjusted after the SCG deactivation to prioritize the first RLC layer or the second RLC layer.
Aspect 29: The method of any of Aspects 17-28, wherein the configuration defines one or more conditions for a conditional primary secondary cell (PSCell) addition or change, and wherein the corrective action includes the conditional PSCell addition or change based at least in part on the configuration.
Aspect 30: The method of Aspect 29, wherein the one or more conditions includes an RLC roundtrip time (RTT) or block error rate (BLER) difference condition, and wherein the conditional PSCell addition or change is based at least in part on the RLC RTT or BLER difference condition being satisfied.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.
Aspect 32: An apparatus for wireless communication at a device, the apparatus comprising one or more memories and one or more processors coupled to the one or
more memories, the one or more processors configured to cause the device to perform the method of one or more of Aspects 1-30.
Aspect 33: An apparatus for wireless communication, the apparatus comprising at least one means for performing the method of one or more of Aspects 1-30.
Aspect 34: A non-transitory computer-readable medium storing code for wireless communication, the code comprising instructions executable by one or more processors to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.
Aspect 36: A device for wireless communication, the device comprising a processing system that includes one or more processors and one or more memories coupled with the one or more processors, the processing system configured to cause the device to perform the method of one or more of Aspects 1-30.
Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a configuration associated with mitigating a radio link control (RLC) layer degradation;
detect the RLC layer degradation based at least in part on an occurrence of an event, wherein the RLC layer degradation is between a first RLC layer and a second RLC layer that are associated with a split bearer; and
perform a corrective action to mitigate the RLC layer degradation based at least in part on the configuration.

2. The apparatus of claim 1, wherein:
the event occurs when an RLC round trip time difference between the first RLC layer and the second RLC layer satisfies a first threshold;
the event occurs when an RLC block error rate difference between the first RLC layer and the second RLC layer satisfies a second threshold; or
the event occurs based at least in part on a defined quantity, where the defined quantity includes a reference signal received power measurement.

3. The apparatus of claim 1, wherein the configuration is a radio resource control configuration that defines one or more conditions associated with performing the corrective action, or the configuration allows a predictive model to run with one or more boundary conditions on UE behavior.

4. The apparatus of claim 1, wherein the configuration defines one or more parameters for a suspension of the first RLC layer or the second RLC layer based at least in part on the RLC layer degradation being an observed RLC layer degradation, and wherein the one or more processors, to perform the corrective action, are further configured to cause the UE to suspend the first RLC layer or the second RLC layer based at least in part on the configuration.

5. The apparatus of claim 4, wherein the configuration indicates one or more of: an RLC round trip time difference threshold, an RLC block error rate difference threshold, or a suspension duration to be applied by the UE.

6. The apparatus of claim 1, wherein the configuration defines one or more parameters for autonomously suspending the first RLC layer or the second RLC layer based at least in part on the RLC layer degradation being a predicted RLC layer degradation, and wherein the one or more processors, to perform the corrective action, are further configured to cause the UE to autonomously suspend the first RLC layer or the second RLC layer based at least in part on the configuration.

7. The apparatus of claim 6, wherein the configuration includes a range configuration, and wherein the range configuration indicates one or more of: a minimum RLC roundtrip time (RTT) for the UE to suspend the first RLC layer or the second RLC layer, a maximum RLC RTT for the UE to suspend the first RLC layer or the second RLC layer, a minimum RLC block error rate (BLER) for the UE to suspend the first RLC layer or the second RLC layer, a maximum RLC BLER for the UE to suspend the first RLC layer or the second RLC layer, a number of grants that the UE is allowed to miss over a time window due to an RLC layer suspension, a maximum time that the UE is able to suspend the first RLC layer or the second RLC layer, or a minimum time that the UE is to wait between two RLC layer suspensions.

8. The apparatus of claim 6, wherein the configuration includes a key performance indicator (KPI) configuration, and wherein the KPI configuration indicates one or more of: a KPI on a throughput on the first RLC layer and the second RLC layer, or a KPI on an observed roundtrip time or block error rate based at least in part on an autonomous UE behavior.

9. The apparatus of claim 1, wherein the one or more processors are further configured to cause the UE to:
transmit an indication of the corrective action taken to mitigate the RLC layer degradation.

10. The apparatus of claim 1, wherein the corrective action includes temporarily suspending the first RLC layer or the second RLC layer, and wherein the one or more processors are further configured to cause the UE to:
complete pending retransmissions prior to temporarily suspending the first RLC layer or the second RLC layer; or
discard all pending retransmissions prior to temporarily suspending the first RLC layer or the second RLC layer, and attempting to retransmit the pending retransmissions via the first RLC layer or the second RLC layer.

11. The apparatus of claim 1, wherein the configuration defines one or more parameters for a secondary cell group (SCG) deactivation associated with the second RLC layer, and wherein the one or more processors, to perform the corrective action, are further configured to cause the UE to perform the SCG deactivation based at least in part on the configuration.

12. The apparatus of claim 11, wherein the configuration indicates one or more of a counter or a timer, and wherein the SCG deactivation is based at least in part on one or more of the counter or the timer.

13. The apparatus of claim 11, wherein the one or more processors are further configured to cause the UE to:
receive an indication of an uplink data split threshold; or autonomously set the uplink data split threshold,
wherein the uplink data split threshold is adjusted after the SCG deactivation to prioritize the first RLC layer or the second RLC layer.

14. The apparatus of claim 1, wherein the configuration defines one or more conditions for a conditional primary secondary cell (PSCell) addition or change, and wherein performing the corrective action includes performing the conditional PSCell addition or change based at least in part on the configuration.

15. The apparatus of claim 14, wherein the one or more conditions includes an RLC roundtrip time (RTT) or block error rate (BLER) difference condition, and wherein the conditional PSCell addition or change is performed based at least in part on the RLC RTT or BLER difference condition being satisfied.

16. An apparatus for wireless communication at a network node, comprising:
one or more memories; and
one or more processors, coupled to the one or more memories, configured to cause the network node to:
transmit a configuration associated with mitigating a radio link control (RLC) layer degradation; and
receive an indication of a corrective action performed to mitigate the RLC layer degradation in accordance with the configuration, wherein the RLC layer degradation is detected based at least in part on an occurrence of an event, and
wherein the RLC layer degradation is between a first RLC layer and a second RLC layer that are associated with a split bearer.

17. The apparatus of claim 16, wherein the configuration defines one or more parameters for a suspension of the first RLC layer or the second RLC layer based at least in part on the RLC layer degradation being an observed RLC layer degradation, and wherein the corrective action includes the suspension of the first RLC layer or the second RLC layer based at least in part on the configuration.

18. The apparatus of claim 16, wherein the configuration defines one or more parameters for a secondary cell group (SCG) deactivation associated with the second RLC layer, and wherein the corrective action includes the SCG deactivation based at least in part on the configuration.

19. The apparatus of claim 16, wherein the configuration defines one or more conditions for a conditional primary secondary cell (PSCell) addition or change, and wherein the corrective action includes the conditional PSCell addition or change based at least in part on the configuration.

20. A method of wireless communication performed by a user equipment (UE), comprising:
receiving a configuration associated with mitigating a radio link control (RLC) layer degradation;
detecting the RLC layer degradation based at least in part on an occurrence of an event, wherein the RLC layer degradation is between a first RLC layer and a second RLC layer that are associated with a split bearer; and
performing a corrective action to mitigate the RLC layer degradation based at least in part on the configuration.
